(19) United States
(12) Patent Application Publication
(10) Pub. No.: US 2002/0114108 A1
(43) Pub. Date: Aug. 22, 2002

(54) Apparatus and method for passive adaptive flying height control in a disc drive

(75) Inventors: Gary Edwin Bement, Frederick, CO (US); Mark Andrew Chapin, Louisville, CO (US); Michael David Mundt, Longmont, CO (US); Jason Wayne Riddering, Prior Lake, MN (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/046,099

(22) Filed: Nov. 6, 2001

Related U.S. Application Data
(60) Provisional application No. 60/269,924, filed on Feb. 19, 2001.

(51) Int. Cl. G11B 5/48

(52) U.S. Cl. 360/245.4

(57) ABSTRACT

An apparatus for adapting flying height of a read/write head over a disc due to changes in temperature in a head disc assembly in a disc drive. The head disc assembly has a base plate and a top cover which encloses a drive motor, the disc supported thereon, and an actuator assembly which transfers data to and from the disc. The actuator assembly has an actuator arm and a suspension having one end connected to a slider carrying the head and an opposite end connected to the actuator arm. At least one shape memory alloy segment is attached to the suspension for moving the slider between a contracted state away from the disc when temperature within the head disc assembly increases and a relaxed state near the disc when temperature within the head disc assembly descreases.

### RELATED APPLICATIONS

This application claims the benefit of priority of U.S. Provisional Patent Application Serial No. 60/269,924 entitled “PASSIVE ADAPTIVE FH CONTROL FOR TPTR,” filed Feb. 19, 2001.

### FIELD OF THE INVENTION

This application relates to magnetic disc drives and more particularly to a disc drive having shape memory alloys in an actuator arm suspension for providing passive control of the flying height of a read/write head.

### BACKGROUND OF THE INVENTION

Disc drives are data storage devices that store digital data in magnetic form on a rotating information storage disc. Modern disc drives comprise one or more rigid information storage discs that are coated with a magnetizable medium and mounted on the hub of a spindle motor for rotation at a constant high speed. Information is stored on the discs in a plurality of concentric circular tracks typically by an array of transducers or “heads” fixed to a slider mounted on a radial actuator arm for movement of the heads in an arc across the surface of the discs.

The actuator arms are driven by an actuator assembly located adjacent to the disc(s) in the disc drive. The actuator assembly includes a plurality of actuator arms. One or more suspensions are attached to the distal end of each actuator arm, where each suspension includes a rigid load beam for supporting each head of the disc drive above the disc. Suspensions are formed with a bend section that exerts a pre-load force on the head toward the disc.

Each of the concentric tracks is generally divided into a plurality of separately addressable data sectors. The recording transducer, e.g. a magnetoresistive read/write head or pole, is used to transfer data between a desired track and an external environment. During a write operation, data is written onto the disc track and during a read operation the head senses the data previously written on the disc track and transfers the information to a host computing system. The overall capacity of the disc drive to store information is dependent upon the disc drive recording density. It is of particular importance in the disc drive art to maximize the disc drive recording density.

An important parameter affecting the recording density of a disc drive is the flying height of the head over the magnetizable medium layer of the information storage disc. The flying height of the head will vary depending upon several factors and thus a tolerance called the head/disc spacing budget is built into the actuator assembly. Smaller head/disc spacing budgets allow for closer spacing of the magnetic signals, i.e., bits, recorded on the information storage disc, which in turn allows for narrower track widths and consequent greater recording densities on the drive. As such, one way to maximize the disc drive recording density is to minimize the head/disc spacing budget. However, there is at least the following major shortcoming with regard to minimizing the head/disc spacing budget.

Included in the head/disc spacing budget are factors such as disc roughness, lube and carbon thickness, thermal pole tip recession (“TPTR”), and part tolerances. Thus, in order to decrease the head/disc spacing budget, these factors must likewise be proportionately decreased or risk contact of the head with the disc surface thereby causing stiction and/or loss of data. Some factors, such as the disc roughness and material thickness can be scaled down as the spacing budget is decreased. However, other factors like TPTR cannot be scaled down. Thus, there is a need to minimize TPTR so that the head/disc spacing budget may be minimized.

TPTR occurs because the materials of the slider have different coefficients of thermal expansion than the materials of the transducer or head. As such, the materials of the slider expand and contract at different rates than the materials of the head with temperature changes. These different rates of expansion and contraction cause the head to protrude beyond the slider and move closer to the disc when the temperature increases, thereby decreasing the head flying height and risking contact with the disc. TPTR does cause some self-correction by changing the air bearing surface of the slider and thereby increasing the flying height. However, this self-correction is not sufficient to overcome TPTR.

One way to fully correct TPTR is to provide an active mechanism to modify flying height, such as an electric current. However, this type of active control requires precise measurement and/or monitoring of the TPTR. Further, such active controls add significant expense to the manufacturing costs. Against this backdrop the present invention has been developed.

### SUMMARY OF THE INVENTION

It is thus desirable to provide an apparatus for adapting flying height of a read/write head over a disc due to changes in temperature in a head disc assembly in a disc drive, which does not require any active control elements.

The head disc assembly has a base plate and a top cover which encloses a drive motor, a disc supported thereon, and an actuator assembly which transfers data to and from the disc. The actuator assembly has an actuator arm and a suspension having one end connected to a slider and an opposite end connected to the actuator arm. The slider carries the head. At least one shape memory alloy segment is attached to the suspension for moving the slider between a contracted state away from the disc when temperature within the head disc assembly increases and a relaxed state near the disc when temperature within the head disc assembly decreases.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive in accordance with a preferred embodiment of the invention.

FIG. 2 is an enlarged partial exploded view of a suspension with an attached slider, as shown in FIG. 1, incorporating a preferred embodiment of the present invention.

FIG. 3 is a perspective view of the suspension of FIG. 2 in a relaxed state.

FIG. 4 is a perspective view of the suspension of FIG. 2 in a contracted state.

FIG. 5 is an exaggerated side view of the suspension of FIG. 3.

FIG. 6 is an exaggerated side view of the suspension of FIG. 4.

### DETAILED DESCRIPTION

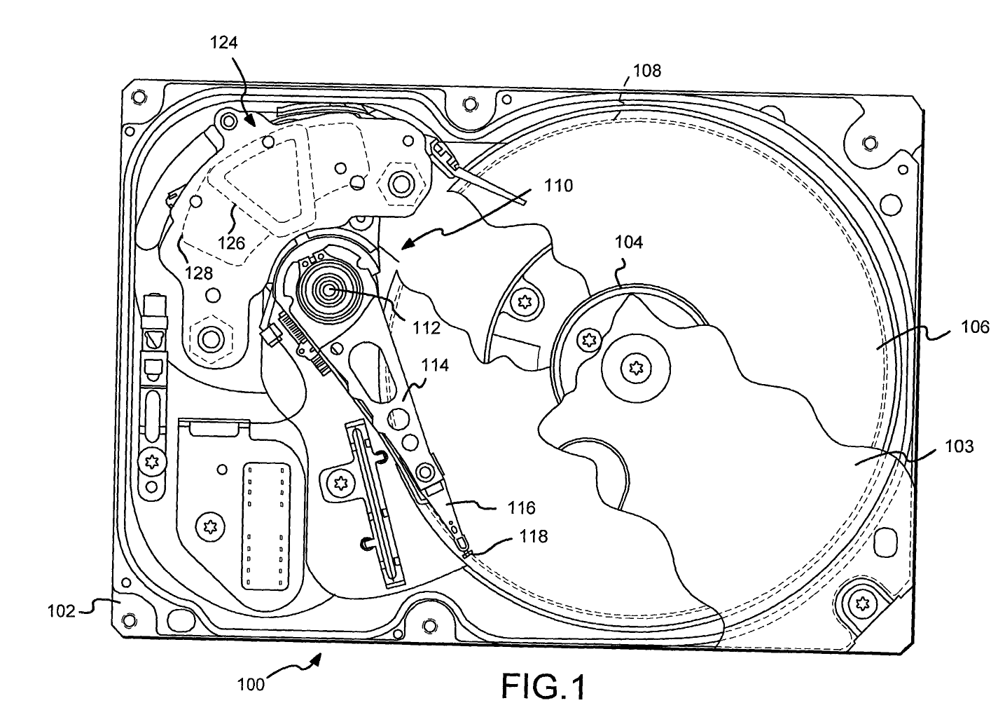

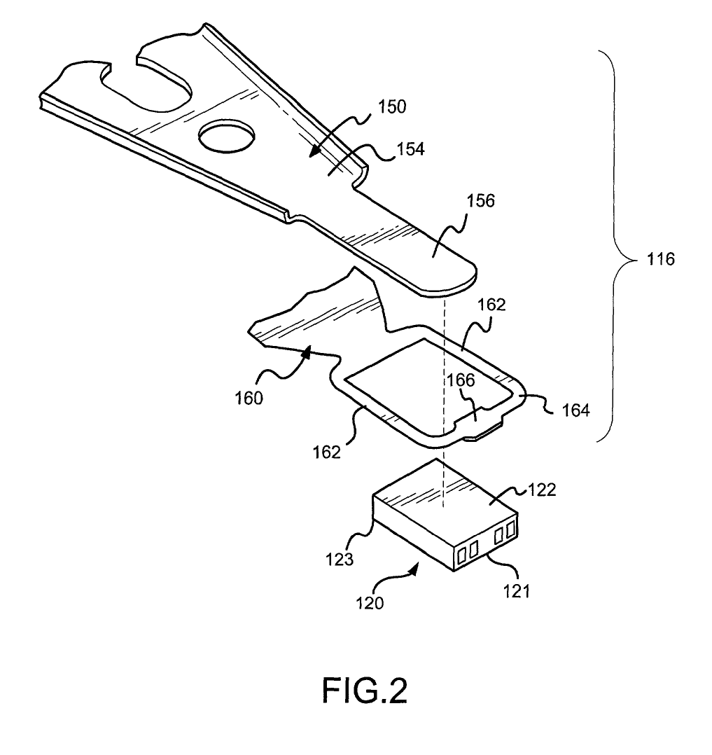

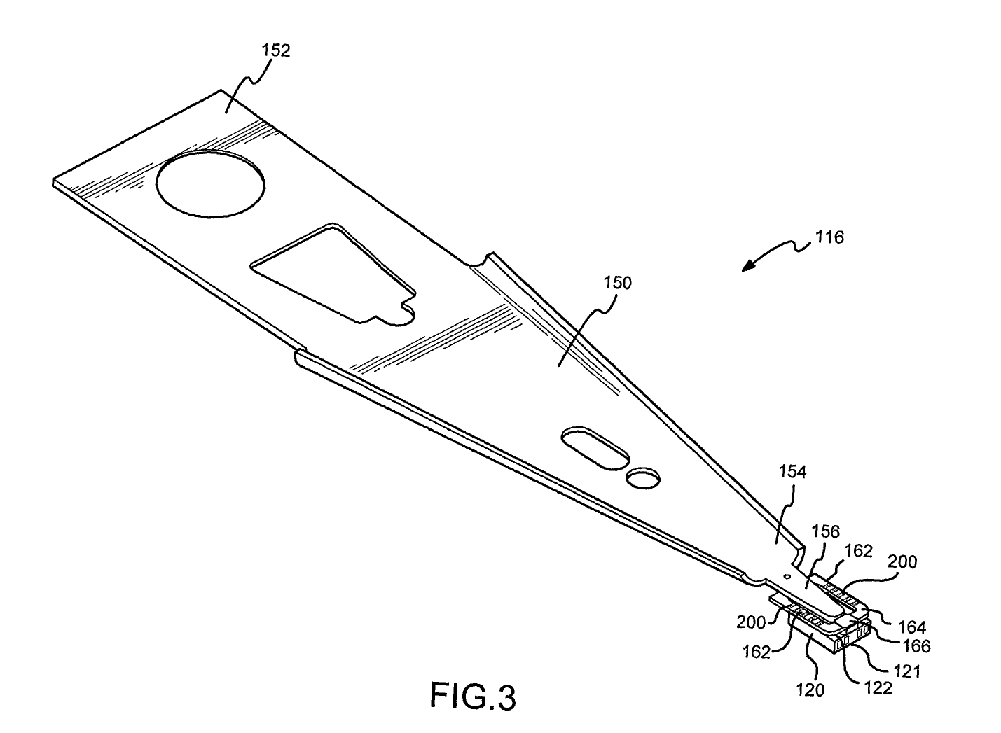

A disc drive 100 constructed in accordance with a preferred embodiment of the present invention is shown in FIG. 1. The disc drive 100 includes a base plate 102 to which various components of the disc drive 100 are mounted. A top cover 103 cooperates with the base 102 to form an internal, sealed environment for the disc drive in a conventional manner. The components include a disc drive spindle motor assembly which includes a spindle motor 104 that rotates one or more information storage discs 106 at a constant high speed. Information is written to and read from tracks 108 on the discs 106 through the use of an actuator assembly 110 which rotates about a bearing shaft assembly 112 positioned adjacent the discs 106. The actuator assembly 110 includes a plurality of actuator arms 114 which extend towards the discs 106, and one or more suspensions or flexures 116 which extend from each of the actuator arms 114. Mounted at the distal end of each of the suspensions 116 is a head (transducer) 118 that includes an air bearing slider 120 (FIG. 3) enabling the head 118 to fly at a head flying height in close proximity above the corresponding surface of the associated information storage disc 106.

The actuator arms 114 each attach a single suspension 116 for holding a slider 120 with a predetermined pre-load force against their respective discs 106. In use, the actuator arms 114 are rotated by the voice coil motor 128 about its axis to move the sliders 120 over the surfaces of the discs 106. Although several embodiments of the present invention are preferably described below with respect to use with a rotary voice coil motor, it is understood that the present invention may be used with any other actuator commonly utilized in disc drives.

Suspensions 116 must be accurately positioned over the discs with a predetermined pre-load force in the downward direction, i.e., toward the disc 106. Suspension pre-load forces are determined and employed so that the air bearing slider 120 will attain an optimal head flying height above the surface of the disc 106 under normal operating conditions. The optimal head flying height is determined by setting a head/disc spacing budget, which is determined by considering various factors including TPTR. As discussed previously, there is a need to minimize the head/disc spacing budget in order to maximize the disc drive recording density.

The air bearing slider 120 is typically formed from a block having a specially etched air bearing surface that forms an air cushion or “bearing” as the disc 106 rotates beneath the slider 120. The hydrodynamic lifting force provided by the air bearing surface acts against a downward pre-load force provided by the suspension 116 to cause the slider 120 to lift off and “fly” a very small distance above the surface of the disc 106 as the disc 106 spins up to its operating speed. This distance is referred to as the slider 120 flying height. Although the flying height of the slider 120 is only a fraction of a micron, this thin film of air between the slider 120 and the disc 106 prevents damage to the fragile magnetic coating on the surface of the disc 106.

The slider 120 has a leading edge 121, a trailing edge 123, an upper surface 122, and a lower surface 124. The slider 120 is typically made of a ceramic type material such as altec, but may be comprise other less expensive materials such as silicon. The head 118 is fixed within the lower surface 124 of the slider 120 near the leading edge 121. The head 118 is made of a transducing material such as copper. The differences in the coefficients of thermal expansion of the materials of the head 118 and the slider 120 cause them to expand and contract at different rates as the temperature changes. As the temperature increases in the disc drive 100, the head 118 expands faster than the slider 120 thereby causing the head 118 to protrude beyond the lower surface 124 of the slider 120. This protrusion of the head 118 lowers the head flying height and increases the risk that the head will crash into the disc 106. This thermal phenomenon is referred to as Thermal Tip Pole Recession (“TPTR”).

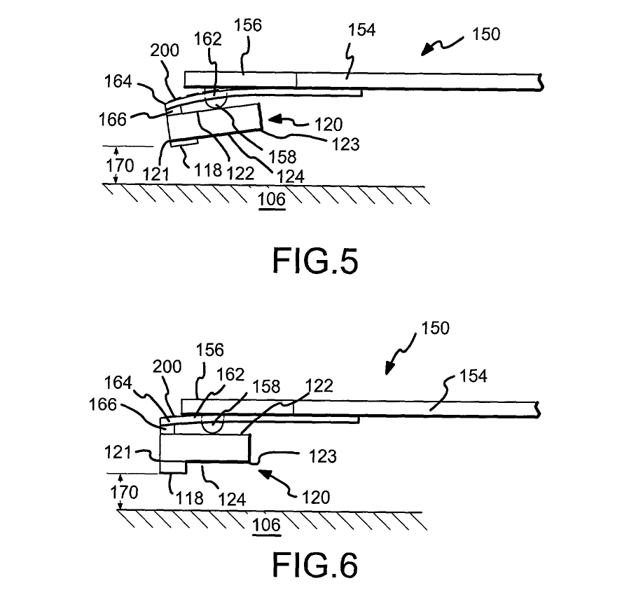

The suspension 116 preferably includes a relatively stiff load beam 150 and a relatively flexible gimbal 160 for attaching the slider 120 to the suspension 116. A first or proximal end 152 (shown in FIG. 3) of the load beam 150 is attached to the actuator arm 114. A second or distal end 154 of the load beam 150 opposite the actuator arm 114 is attached (such as by welding or by an adhesive) to the more flexible gimbal 160 which, in turn, is fixed to the slider 120. A distal end of the gimbal 160 includes a cutout region defined by two parallel arms or flexure beams 162 and a cross beam 164 defining an attachment pad 166. A tongue 156 of the load beam 150 typically protrudes within the cutout region of the gimbal 160 so that a dimple 158 (shown in FIGS. 5 and 6) located on the bottom of the tongue 156 may contact the top surface 122 of the slider 120 to transfer the preload force directly to the slider 120. The attachment pad 166 of the gimbal 160 is secured to the top surface 122 of the slider, such as by an adhesive, so that the flexure beams 162 provide a resilient connection between the slider 120 and the relatively stiff load beam 150. The resilient connection provided by the gimbal 160 is important to allow the slider 120 to pitch and roll (i.e., “gimbal”) while following the topography of the rotating disc 106.

In a preferred embodiment of the present invention, at least one discrete segment 200 comprising a shape memory alloy (“SMA”) is attached to the suspension 116 as shown in FIG. 3. SMAs expand and contract based upon changes in temperature. Thus when the SMA contracts, it causes the suspension to deflect thereby changing the flying height of the slider 120. In this way, the SMA segment 200 provides passive control of the flying height of the slider 120 when the temperature in the disc drive 100 changes.

Either one or a plurality of the segments 200 may be attached to the beams 162 by a number of methods including sputtering and use of epoxies or other adhesives. A multitude of different compositions of SMA may be used, including, but not limited to, the following: gold-cadmium, silver-cadmium, copper-aluminum-nickle, copper-tin, copper-zinc, copper-zinc-aluminum, indium-titanium, indium-thalium, iron-platinum, nickle-aluminum, iron-manganese-silicon, manganese-copper, and nickle-titanium. Further, each of the aforementioned SMAs may comprise different percentages of each component metal. Every SMA has a crystalline transition temperature that varies depending on the composition of the SMA. Preferably, the type of SMA should be chosen after taking into account the following non-exhaustive list of factors: the strength, flexibility, and thickness of the gimbal 120, the coefficients of thermal expansion of the slider 120 and the head 118, the desired crystalline transition temperature, and the desired number of the SMA segments 200.

The ambient temperature in a disc drive 100 usually varies from room temperature to 160 degrees Fahrenheit or 70 degrees Celsius. Within this temperature range, the SMA segment 200 may occupy two different phases: martensite and austenite. The SMA segment 200 exists in the martensite phase when the ambient temperature is below its particular crystalline transition temperature. As the ambient temperature rises above the crystalline transition temperature, the SMA undergoes a phase change to the austenite phase. The phase change from martensite to austenite causes the SMA segment to contract. SMAs are unique in that any deformation of the material in the cool state (martensite) can be undone by taking it to the heated state (austenite).

FIGS. 3-6 show how the phase transition of the SMA segments 200 on the flexure beam 162 of the gimbal 160 adapt to overcome the TPTR caused by an increase in temperature in the disc drive. It should be noted that FIGS. 3-6 are substantially exaggerated to illustrate the changes in the present invention, which changes actually constitute a fraction of a micron.

FIGS. 3 and 5 shows the present invention in the normal or cool (martensite) state. As shown in FIG. 5, in the normal state the lower surface 124 of the slider 120 is angled relative to the disc 106 such that the leading edge 121 is closer to the disc than the trailing edge 123. The head 118 barely protrudes beyond the lower surface 124 and flies above the disc at the head flying height illustrated by a double-headed arrow 170.

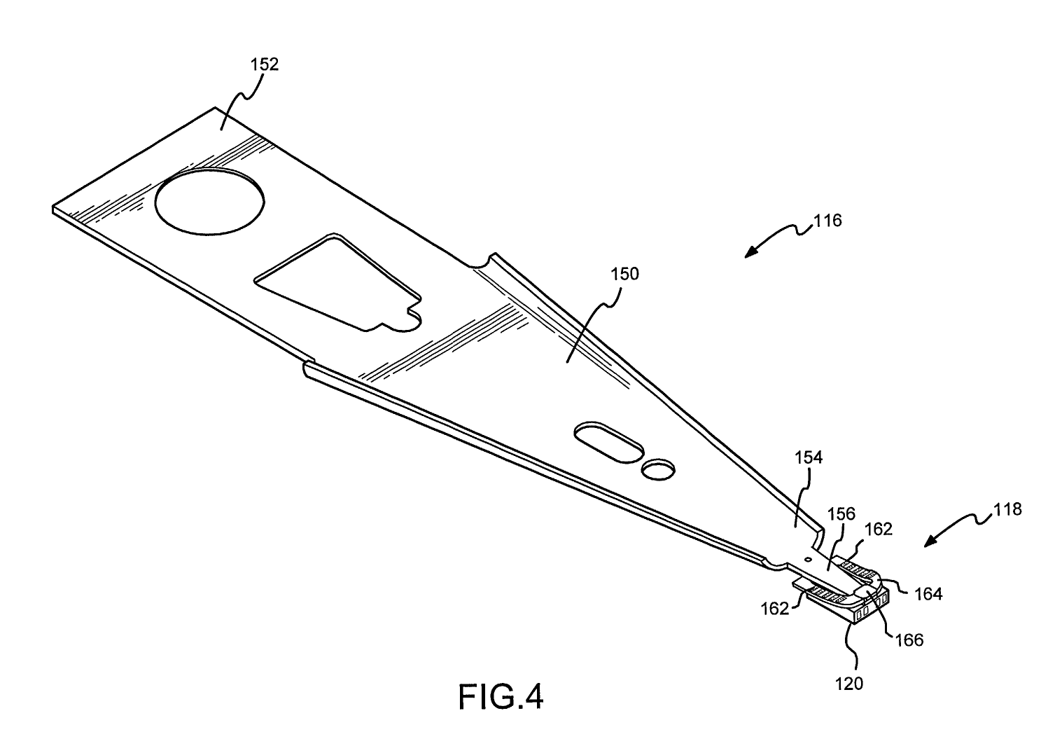

FIGS. 4 and 6 show how the present invention adapts and compensates for TPTR when the ambient temperature in the disc drive 100 increases. As discussed above, an increase in temperature causes the head 118 to expand and protrude beyond the lower surface 124 of the slider 120 thereby decreasing the head flying height and increasing the risk of contact between the head 118 and the disc 106. However, as the temperature increases, the SMA segments 200 undergo the phase change from martensite to austenite and contract in length. The contraction of the segments 200 cause the flexure beams 162 to bend upward and away from the disc 106. As the flexure beams 162 bend upward, they cause the connected cross beam 164 and bonding pad 166 to likewise bend upward. The bonding pad 166, in turn, pulls the slider 120, and thus the head 118, upward and away from the disc, thereby increasing the head flying height. In this way, the SMA segments compensate for the expansion of the head 118 by increasing the slider 120 flying height, thereby maintaining substantially the same head flying height 170 even with presence of TPTR.

In a preferred embodiment of the present invention, five SMA segments 200 are positioned on each flexure beam 162 of the gimbal 160. More preferably, each of the five SMA segments 200 on each flexure beam 162 has a different transition temperature. Even more preferably, the five SMA segments have the following transition temperatures: 40°, 50°, 55°, 60°, 65° Celcius (100°, 120°, 130°, 140°, and 150° degrees Fahrenheit), with the 40° segment 200 positioned adjacent the cross beam 164. In order to obtain symmetry of deflection in the gimbal 160, the different SMA segments 200 are preferably arranged in parallel order on each of the flexure beams 162. However, it should be noted that the SMA segments 200 may be positioned anywhere on the flexure beams so long as they act to move the slider 120 and the head 118 away from the disc 106 when the temperature rises beyond the crystalline transition temperature. For example, the segments 200 may be positioned near the cross beam 164 or centered about the dimple 158. Alternatively, multiple segments 200 may span the entire length of the flexure beams 162, thereby allowing a very smooth transition as the temperature rises. As a general rule, the more segments 200 used, the more the gimbal 160 will bend when the temperature rises.

Further, multiple segments 200 of the same SMA may be used, or each segment may comprise a different SMA, or any variation thereof. In order to achieve a wider range of flying height compensation, it is preferable to use different SMAs with different crystalline transition temperatures. Further, use of multiple segments of multiple types of SMAs make the transition more smooth over a wide temperature range. In contrast, use of multiple SMA segments 200 having the same transition temperature will cause greater deflection of the gimbal over a more narrow range of temperatures.

In contrast to the TPTR solutions that utilize active flying height compensation, the adaptive nature of the SMAs allows for passive control of the flying height and does not require additional or active control elements, such as the application of electric current, to make the change.

Although the foregoing discusses a specific type of suspension, it is important to note that the present invention may be used with any type of suspension. For example, it may be used with a suspension where the gimbal is positioned on top of the load beam (opposite the disc) or in a suspension where the gimbal is integrated with the load beam.

In summary, a suspension (such as 116) for adapting flying height of a read/write head (such as 118) due to changes in temperature in a disc drive (such as 100) comprises a load beam (such as 150), a gimbal (such as 160) positioned at one end of the load beam (such as 150), a slider (such as 120) attached to the gimbal (such as 160), wherein the head (such as 118) is fixed to the slider (such as 120), and a shape memory alloy segment (such as 200) attached to the gimbal (such as 160). The shape memory alloy may comprise nickel-titanium. A distal end of the gimbal (such as 160) has two parallel flexure beams (such as 162) connected by a cross beam (such as 164) and the cross beam (such as 164) defines an attachment pad (such as 166) that is secured to a top surface (122) of the slider (such as 120). The gimbal (such as 160) may be attached to a lower surface of the load beam (such as 150), attached to an upper surface of the load beam (such as 150), or integrated with the load beam (such as 150).

The suspension (such as 116) may have second shape memory alloy segment (such as 200), a plurality of additional shape memory alloy segments (such as 200), or nine additional shape memory alloy segments (such as 200) attached to the gimbal (such as 160), wherein equal numbers of shape memory alloy segments (such as 200) are attached to each of the flexure beams (such as 162) of the gimbal (such as 160). The SMA segments (such as 200) may substantially span the entire length of the flexure beams (such as 162) or be positioned near the cross beam (such as 164) of the gimbal (such as 160). The shape memory alloy segments (such as 200) on each of the flexure beams (such as 162) may have different transition temperatures.

A disc drive (such as 100) has a base plate (such as 102) and a top cover (such as 103) enclosing a drive motor (such as 104) carrying a disc (such as 106) and an actuator assembly (such as 110) having an actuator arm (such as 114), a suspension (such as 116) having one end connected to the slider (such as 120) and an opposite end connected to the actuator arm (such as 114), and at least one shape memory alloy segment (such as 200) attached to the suspension (such as 116). The shape memory alloy segment (such as 200) moves the slider (such as 120) between a contracted state away from the disc (such as 106) when temperature within the head disc assembly increases and a relaxed state near the disc (such as 106) when temperature within the head disc assembly decreases.

The disc drive (such as 100) may have at least three shape memory alloy segments (such as 200) attached to opposite sides of the gimbal (such as 160). Each of the segments (such as 200) on each side of the gimbal (such as 160) may be composed of a different shape memory alloy. All of the shape memory alloy segments (such as 200) may be composed of at least two different shape memory alloys. Each of the segments (such as 200) on each side of the gimbal (such as 160) may have a different transition temperature.

The load beam (such as 150) has a proximal end (such as 152) and a distal end (such as 154), wherein the proximal end (such as 152) is attached to the actuator arm (such as 114), and the distal end (such as 154) forms a tongue (such as 156) having a dimple (such as 158) formed in a lower surface of the tongue (such as 156) for transferring a preload force to the slider (such as 120). The gimbal (such as 160) is positioned near the distal end (such as 154) of the load beam (such as 150) with one end of the gimbal (such as 160) forming a cutout region bordered by two side arms (such as 162) and a cross beam (such as 164). The cross beam (such as 164) defines an attachment pad (such as 166) attached to the slider (such as 120). The dimple (such as 158) of the load beam (such as 150) protrudes through the cutout region to make contact with the slider (such as 120) and to permit the slider (such as 120) to pivot about the dimple (such as 158). The shape memory alloy segments (such as 200) may be centered about the dimple (such as 158).

It will be clear that the present invention is well adapted to attain the ends and advantages mentioned as well as those inherent therein. While a presently preferred embodiment has been described for purposes of this disclosure, numerous changes may be made which will readily suggest themselves to those skilled in the art and which are encompassed in the spirit of the invention disclosed and as defined in the appended claims.

What is claimed is:

1. A suspension for adapting flying height of a read/write head due to changes in temperature in a disc drive, the suspension comprising:
a load beam;
a gimbal positioned at one end of the load beam;
a slider attached to the gimbal, wherein the head is fixed to the slider; and
a shape memory alloy segment attached to the gimbal.

2. The suspension of claim 1 wherein the shape memory alloy segment comprises nickel-titanium.

3. The suspension of claim 1 wherein a distal end of the gimbal has two parallel flexure beams connected by a cross beam, and the cross beam defines an attachment pad that is secured to a top surface of the slider.

4. The suspension of claim 3 further comprising a second shape memory alloy segment attached to the gimbal, wherein one shape memory alloy segment is attached to each of the flexure beams of the gimbal.

5. The suspension of claim 3 further comprising a plurality of shape memory alloy segments attached to each of the flexure beams to span a substantial portion of the length of the flexure beams.

6. The suspension of claim 3 further comprising nine additional shape memory alloy segments attached to the gimbal, wherein five shape memory alloy segments are attached to each of the flexure beams of the gimbal.

7. The suspension of claim 6 wherein each of the five shape memory alloy segments on each of the flexure beams has a different transition temperature.

8. The suspension of claim 7 wherein the transition temperatures comprise: 40°, 50°, 55°, 60°, and 65° Celcius.

9. The suspension of claim 3 wherein the gimbal is attached to a lower surface of the load beam.

10. The suspension of claim 3 wherein the gimbal is attached to an upper surface of the load beam.

11. The suspension of claim 3 wherein the gimbal is integrated with the load beam.

12. A disc drive comprising:
a head disc assembly having a base plate and a top cover enclosing a drive motor carrying a disc and an actuator assembly having an actuator arm;
a suspension having one end connected to a slider and an opposite end connected to the actuator arm; and
at least one shape memory alloy segment attached to the suspension for moving the slider between a contracted state away from the disc when temperature within the head disc assembly increases and a relaxed state near the disc when temperature within the head disc assembly decreases.

13. The disc drive of claim 12 wherein the shape memory alloy is nickel-titanium.

14. The disc drive of claim 12 wherein at least three shape memory alloy segments are attached to opposite sides of the suspension.

15. The disc drive of claim 14 wherein each of the shape memory alloy segments on each side of the suspension are composed of a different shape memory alloy.

16. The disc drive of claim 14 wherein each of the shape memory alloy segments on each side of the suspension have a different transition temperature.

17. The disc drive of claim 12 wherein the suspension comprises:
a load beam having a proximal end and a distal end, wherein the proximal end is attached to the actuator arm, and the distal end forms a tongue having a dimple formed on a lower surface of the tongue for transferring a preload force to the slider; and
a gimbal attached to the distal end of the load beam, one end of the gimbal forming a cutout region bordered by two side arms and a cross beam, the cross beam defining an attachment pad attached to the slider, wherein the dimple of the load beam protrudes through the cutout region to make contact with the slider and to permit the slider to pivot about the dimple.

18. The apparatus of claim 17 wherein a plurality of memory alloy segments are attached to each of the gimbal side arms.

19. The apparatus of claim 18 wherein the shape memory alloy segments are centered about the dimple.

20. An apparatus for providing passive control of flying height of a slider over a disc within a head disc assembly in a disc drive, the head disc assembly having a base plate and a top cover enclosing a drive motor about which the disc spins and an actuator assembly having an actuator arm, the apparatus comprising:
a suspension having one end connected to a slider and an opposite end connected to the actuator arm, wherein the slider flies above the disc at a predetermined flying height; and
means attached to the suspension for increasing the flying height of the slider when the temperature in the head disc assembly increases and decreasing the flying height of the slider when the temperature decreases.

21. The apparatus for claim 20 wherein:
the suspension comprises a load beam attached at one end to the actuator arm and a gimbal positioned at another end of the load beam, wherein the means is attached to the gimbal.

22. The apparatus of claim 20 wherein the means comprises:
at least one shape memory alloy segment.

23. The disc drive of claim 20 wherein the means comprises:
at least three shape memory alloy segments attached to opposite sides of the suspension.

24. The disc drive of claim 20 wherein the means comprises:
at least one nickel-titanium segment.
